(19) United States
(12) Patent Application Publication
(10) Pub. No.: US 2022/0402147 A1
(43) Pub. Date: Dec. 22, 2022

(54) Robotic Cell and Method of Operating Same

(71) Applicant: TECHJIG INC., Saint-Agapit (CA)

(72) Inventors: Lawrence Martin, Saint-Apollinaire (CA); Julien St-Hilaire, Levis (CA)

(73) Assignee: TECHJIG INC., Saint-Agapit (CA)

(21) Appl. No.: 17/841,824

(22) Filed: Jun. 16, 2022

Related U.S. Application Data
(60) Provisional application No. 63/202,632, filed on Jun. 18, 2021.

(51) Int. Cl. B25J 15/08; B25J 15/00; B25J 11/00

(52) U.S. Cl. CPC B25J 15/08; B25J 15/0038; B25J 11/005

(57) ABSTRACT

A robotic welding cell is provided, and includes a workstation to receive at least one workpiece, a tool support comprising at least one tool and a robot. The robot includes a robot arm being displaceable in a 3D environment of the workstation, and a robot end effector operatively coupled to the robot arm at a free end thereof. The robot end effector has a gripper adapted to separately and selectively seize and release the at least one tool from the tool support and the at least one workpiece. The tool support is within reach of the gripper such that the robot is operable to manipulate and position the workpiece within the workstation using the gripper and perform a predetermined operation on or around the workpiece using the tool held by the gripper.

### CROSS-REFERENCE TO RELATED APPLICATIONS

This application claims priority under 35 U.S.C. § 119(e) to U.S. provisional patent application No. 63/202,632, filed Jun. 18, 2021, entitled “ROBOTIC CELL AND METHOD OF OPERATING SAME”, the entirety of which is hereby incorporated by reference.

### TECHNICAL FIELD

The technical field generally relates to a robotic cell, and more particularly to a robotic welding cell for welding workpieces.

### BACKGROUND

Robotic cells (or robotic cell units) are systems that include a robot, a controller, and other peripherals such as a safety environment that are typically used to perform a repetitive task, such as drilling a hole, performing a weld, bending a tube, etc. They are sometimes referred to as workcells. Robotic cell units often cooperate with other components, such as a conveying assembly, a loader and/or an unloader which position workpieces in the cell unit to allow the robot to perform its given task on the workpiece, and move the workpieces out of the cell unit once the task is performed.

Known robotic cell units can include specific robot-exclusive tools to be manipulated by the robot, which can be costly and necessitate the replacement of otherwise functioning tools.

It would be particularly advantageous to provide an apparatus, such as a robotic cell unit for performing tasks in a more efficient, more precise, more accurate, more reliable, more adjustable, more versatile, more adaptable, more ergonomic and/or more desirable manner, than what is possible with available products and devices.

It would thus be useful to be able to provide such an improved apparatus which would be able to overcome or at the very least minimize some of known drawbacks and/or deficiencies associated with conventional methods and/or devices, for example.

### SUMMARY

According to a first aspect, there is provided a robotic cell including a workstation adapted to receive at least one workpiece, a tool support comprising at least one tool, and a robot. The robot has a robot base connected to or positioned proximate the workstation, a robot arm operatively coupled to the robot base and being displaceable in a three-dimensional (3D) environment of the workstation, the robot arm having a free end, and a robot end effector operatively coupled to the free end and comprising a gripper adapted to separately and selectively seize and release the at least one tool from the tool support and the at least one workpiece. The tool support is within reach of the gripper, and the robot is operable to manipulate and position the workpiece within the workstation using the gripper and perform a predetermined operation on or around the workpiece using the tool held by the gripper.

According to a possible embodiment, the robotic cell further includes a coupling assembly including a gripper coupling removably connectable to the tool and defining a gripper interface, and wherein the gripper includes a gripper jaw adapted to engage the gripper interface to seize the tool.

According to a possible embodiment, the gripper interface comprises a gripper anchor preventing axial movement of the tool relative to the robot end effector when the gripper engages the gripper interface.

According to a possible embodiment, the gripper jaw comprises two or more gripper fingers provided with gripping attachments, the gripping attachments being complementarily shaped with regards to a portion of the gripper anchor to facilitate engagement of the gripper interface via the gripper.

According to a possible embodiment, the gripper anchor comprises a pair of protrusions extending opposite one another on either sides of the gripper coupling, and wherein each gripping attachment comprises a recess shaped and adapted to receive a corresponding one of the protrusions.

According to a possible embodiment, the coupling assembly further comprises a stabilizing coupling removably connectable to the tool in a spaced apart relation to the gripper coupling, and wherein the robot end effector comprises a stabilizer connectable to the stabilizing coupling.

According to a possible embodiment, one of the stabilizing coupling and the stabilizer comprises a male connector, and wherein the other one of the stabilizing coupling and the stabilizer comprises a female connector.

According to a possible embodiment, the stabilizer is pivotally connected to the stabilizing coupling.

According to a possible embodiment, the tool support comprises a tool holster, and wherein the gripper coupling comprises a holster interface adapted to engage the tool holster to position the tool in a predetermined holstered position on the tool holster.

According to a possible embodiment, the tool holster comprises a holster plate and holster studs extending outwardly from the holster plate, and wherein the tool holster interface comprises holster apertures shaped and adapted to receive the holster studs therein.

According to a possible embodiment, the tool support comprises a mast extending in the 3D environment of the workstation and comprising a support bracket adapted to uphold a cable connected to the tool.

According to a possible embodiment, the tool support comprises a spool connected to the mast, the support bracket being connected to the spool, and wherein the spool is adapted to unwind to enable movement of the support bracket.

According to a possible embodiment, the spool comprises a self-retracting mechanism.

According to a possible embodiment, the tool support comprises a support arm pivotally connected to a distal end of the mast, the spool and the support bracket being connected to the support arm.

According to a possible embodiment, the robotic cell further includes a modular element library provided proximate the workstation and being accessible by the gripper, the modular element library comprising a plurality of modular elements adapted to be seized, manipulated and positioned in the workstation by the gripper.

According to a possible embodiment, the modular elements are adapted to cooperate with at least one other modular element to define a workpiece support structure.

According to a possible embodiment, the robotic cell is a robotic welding cell, and wherein the at least one tool comprises a welding torch.

According to another aspect, there is provided a method of performing a predetermined operation using a robot. The method includes grabbing a workpiece using a gripper mounted at a free end of a displaceable robot arm of the robot, positioning and releasing the workpiece in a workstation using the gripper, grabbing a tool located in a tool support using the gripper, performing the predetermined operation on the workpiece using the tool held by the gripper, setting down the tool in the tool support using the gripper, and grabbing and removing the workpiece from the workstation using the gripper.

According to a possible embodiment, the method further includes the step of placing modular elements in the workstation using the gripper to create a workpiece support structure prior to grabbing the workpiece, and wherein the step of positioning and releasing the workpiece in a workstation using the gripper comprises positioning and releasing the workpiece on the workpiece support structure using the gripper.

According to a possible embodiment, the step of grabbing the tool comprises grabbing the tool at two separate grasping locations using the gripper.

According to a possible embodiment, the grasping locations define one or more contact point, and wherein the gripper is adapted to contact the tool at the contact points when grabbing the tool.

According to a possible embodiment, the gripper is adapted to contact the tool at three separate contact points.

According to another aspect, there is provided a coupling assembly connectable to a tool to be manipulated by a robot having a robot end effector provided with a gripper. The coupling assembly includes a gripper coupling provided adjacent a proximal end of the tool and having a gripper interface defining at least two gripping surfaces engageable by the gripper, and a stabilizing coupling spaced apart from the gripper coupling along the tool and comprising a stabilizing gripping site engageable with the robot. The coupling assembly is detachably engageable by the robot at the at least two gripping surfaces and the stabilizing gripping site.

According to another aspect, there is provided a robot end effector in combination with a coupling assembly mounted to a tool to be gripped by the robot end effector and manipulated by a robot. The coupling assembly includes a gripper coupling provided adjacent a proximal end of the tool and having a gripper interface defining at least two gripping surfaces engageable by the robot end effector; and a stabilizing coupling spaced apart from the gripper coupling along the tool and comprising a stabilizing gripping site engageable with the robot. The robot end effector includes a gripper comprising a gripper jaw adapted to engage the at least two gripping surfaces to seize the tool, and a stabilizer spaced apart from the gripper and engageable with the stabilizing gripping site of the stabilizing coupling. The robot end effector is adapted to detachably engage the tool at the at least two gripping surfaces and the stabilizing gripping site of the coupling assembly.

### BRIEF DESCRIPTION OF THE DRAWINGS

FIG. 1 is a perspective view of a robotic cell including a robot, according to an embodiment.

FIG. 2 is a perspective view of a robot end effector of the robot shown in FIG. 1, the robot end effector comprising a gripper, according to an embodiment.

FIG. 3 is a perspective view of a tool provided with a coupling assembly engageable by the gripper, according to an embodiment.

FIG. 4 is a perspective view of an alternate embodiment of the robot end effector and coupling assembly, showing a ring for holding the tool, according to an embodiment.

FIG. 5 is a perspective view of an alternate embodiment of the robot end effector and coupling assembly, showing a linear connector engageable with the tool, according to an embodiment.

FIG. 6 is a side elevation view of the robot end effector, tool and coupling assembly shown in FIG. 5.

FIG. 7 is an exploded, rear perspective view of the robot end effector shown in FIG. 5, showing the linear connector spaced from a connector opening defined in a portion of the coupling assembly, according to an embodiment.

FIG. 8 is a front perspective view of the robot end effector shown in FIG. 7, showing gripper recesses defined on components of the coupling assembly, and gripper anchors extending from components of the robot end effector, according to an embodiment.

FIG. 9 is a perspective view of components of a workstation of the robotic cell shown in FIG. 1, showing a tool support according to an embodiment.

FIG. 10 is a perspective view, enlarged, of a tool holster of the tool support shown in FIG. 9, showing the tool engaging the tool holster according to an embodiment.

FIG. 11 is a front perspective view of the tool shown in FIG. 10, showing a pair of holster apertures adapted to cooperate with the tool holster, according to an embodiment.

FIG. 12 is a schematic representation of a control assembly of the robotic cell, according to an embodiment.

### DETAILED DESCRIPTION

As will be explained below in relation to various embodiments, the present disclosure describes apparatuses, systems and methods for various operations, such as the manipulation of workpieces and tools using a robotic manipulator.

The present disclosure relates to a robot cell and corresponding robot for performing tasks, such as welding, on workpieces loaded into a workstation via the robot. It should be understood that, as used herein, the expression “workpiece” can refer to components or parts being manipulated or otherwise worked on, such as by the robot, for example. The robot can include a robot end effector provided with a gripper operable to seize, manipulate, operate and release parts (e.g., workpieces) and various tools. The gripper is adapted to grab and release a tool as needed, thereby increasing the dexterity and flexibility of the robot. The robotic cell can further include a library containing a plurality of modular elements of various shapes and sizes. The modular elements can also be grabbed, manipulated and released in the workstation by the gripper. The robot and its gripper are operable to form structures, such as welding fixtures, in the workstation using the modular elements. The robot can then be used to grab and load the workpieces into the structure, subsequently pick up a tool from its holster, operate the tool to perform a task, set the tool back in its holster, and finally grab and unload the workpiece from the fixtures. The robot can then cyclically repeat these steps, as desired.

The robot cell can also include a system to adapt standard tools to the ergonomics of the gripper. The system can therefore enable the integration of standard tools and equipment to the robot cell. The system includes a coupling assembly removably engageable with the tool and includes a gripper interface engageable by the gripper. The coupling assembly further includes a stabilizing coupling spaced from the gripper interface and engageable by the robot such that the tool is engaged (e.g., held) at different locations. The coupling assembly also enables a worker to grab and use the tool such that the same tool can be shared by the robot and the worker. In other words, the connection of the coupling assembly on the tool does not prevent a worker from using the tool, for example, to accomplish complex tasks, and leave repetitive work to the robot.

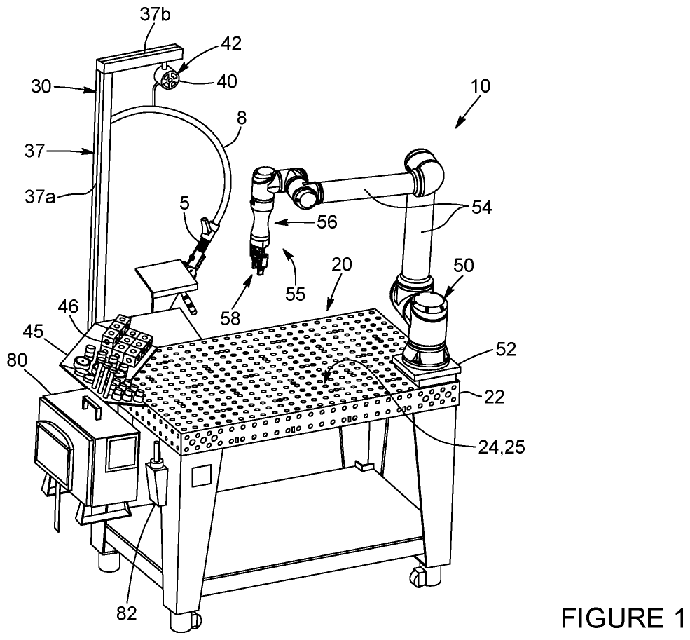

With reference to FIG. 1, a robotic cell (or “robot cell”, or “robot cell unit”) 10 is shown according to an embodiment. In this embodiment, the robot cell 10 includes a workstation 20, a tool support 30, a tooling library 45 and a manipulator or robot 50. The manipulator or robot 50 of the robot cell 10 and corresponding components can be operated to perform tasks, such as welding, on parts (also referred to as “workpieces”) positioned in the workstation 20 and using a tool 5, such as a welding torch. Although the present disclosure describes the robot cell as a robotic welding cell particularly adapted to perform welds using the robot, it should be understood that the robot cell can be used to perform other tasks, and that the task of welding is used as an example to facilitate comprehension. For example, the robot cell can be used to drill, cut, glue, deburr, sand, grind, paint, etc., and can therefore be adapted to grab and manipulate the corresponding tool for the task.

The workstation 20 can therefore include a welding table 22 having a top surface 24 defining a work surface 25 for receiving the workpieces. As will be described further below, the welding table 22 can be adapted to cooperate with the components of the tooling library 45 to facilitate the accomplishment of certain tasks. As seen in FIG. 1, the robot 50 is coupled to the welding table 22, and more specifically, mounted to the top surface 24 of the welding table 22. However, it is appreciated that other configurations are possible and may be used, such as connecting the robot 50 to a side of the welding table 22 or next to and/or spaced from the workstation 20. In some embodiments, the robot 50 includes a robot base 52 securable to the welding table 22, a robot arm 54 coupled to the robot base 52 and a robot end effector 56 provided at a free end 55 of the robot arm 54. The robot arm 54 is displaceable in a 3D environment of the workstation 20, for example, above the work surface 25 of the welding table 22.

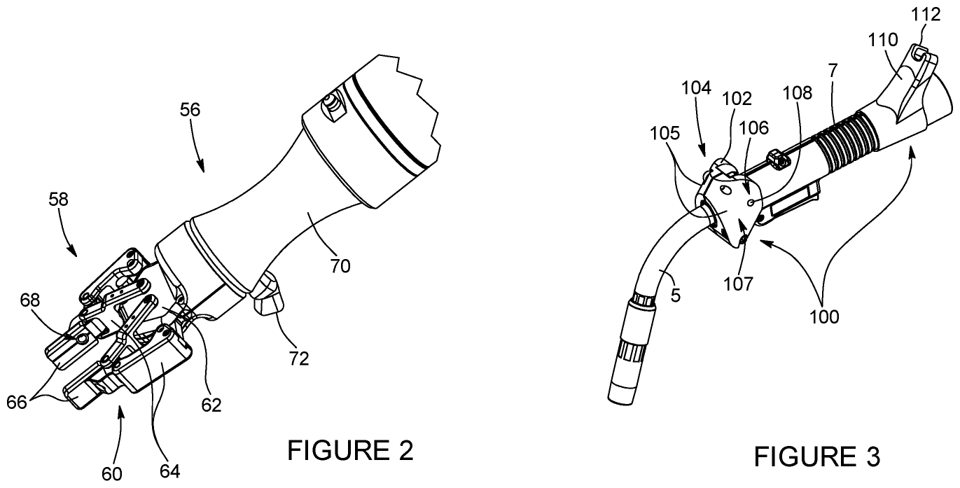

In some embodiments, the robot end effector 56 is operatively coupled to the free end 55 and includes a gripper 58 adapted to separately and selectively seize and release the tool from the tool support 30, the components of the tooling library 45 and the workpiece(s). More particularly, the robot 50 is operable to manipulate and position the workpiece within the workstation 20 using the gripper 58 and perform a predetermined task on or around the workpiece using the tool 5 held by the gripper 58. With reference to FIG. 2, in addition to FIG. 1, the gripper 58 can include a gripper jaw 60 operable to selectively seize and release desired components (e.g., the tool 5, the workpiece, etc.). In this embodiment, the gripper jaw 60 has a jaw base 62 with two or more gripper fingers 64 adapted to move relative to one another in order to grasp components within the workstation. More specifically, and as seen in FIG. 2, the gripper jaw 60 includes a pair of gripper fingers 64 pivotally connected to the jaw base 62 and operable to move toward and away from one another (e.g., similar to tongs) to grab one or more components between the fingers 64.

The gripper fingers 64 can include gripping attachments 66 shaped and adapted to contact the component to be grabbed by the gripper 58 (e.g., the tool, the workpiece, etc.). In some embodiments, and as will be described further below, the gripping attachments 66 are complementarily shaped with respect to a portion of the tool 5. Referring to FIGS. 2 and 3, the robot cell can include a coupling assembly 100 connectable to the tool 5, and allowing the robot end effector 56 to engage the tool, e.g., the engagement between the robot end effector 56 and the tool 5 is performed via the coupling assembly 100. In this embodiment, the coupling assembly 100 includes a gripper coupling 102 removably mounted to the tool 5 and defining a gripper interface 104 adapted to facilitate the seizure of the tool 5 by the gripper 58. More specifically, in this embodiment, the gripper coupling 102 includes a pair of complementary portions 105 coupled to one another about the tool 5, and defining a pair of gripping surfaces 107 engageable by the gripper 58.

The gripper coupling 102 can be positioned along the tool 5, such as proximate a proximal end, or substantially in a middle thereof. As seen in FIG. 3, the tool 5 can include a handle 7 at the proximal end thereof, with the gripper coupling 102 being provided at a distal end of the handle 7, although other configurations are possible and may be used.

In some embodiments, the gripper coupling 102 includes a gripper anchor 106, whereby the gripping attachments 66 are complementarily shaped with regards to a portion of the gripping surfaces 107 and/or the gripper anchor 106 to facilitate engagement of the gripper interface 104 by the gripper 58. The gripper anchor 106 can be adapted to block, or at least partially obstruct axial movement of the gripper 58 relative to the coupling assembly 100 (e.g., the gripper coupling 102) when the gripping attachments 66 engage the gripper anchor 106. It should be noted that, as used herein, the expression “axial movement” can refer to a movement of an element following any given substantially straight axis, such as a translational movement. In some embodiments, the gripper anchor 106 includes one or more protrusions 108 extending from the gripper coupling 102, and at least one of the gripping attachments 66 of the gripper fingers 64 includes a recess 68 shaped and adapted to receive the protrusion 108 therein. In this particular embodiment, the gripper anchor 106 includes a pair of protrusions 108 extending on either side of the gripper coupling 102 (e.g., the protrusions 108 extend from respective complementary portions 105 of the gripper coupling 102). As such, it is noted that the gripping attachments 66 each include one recess 68 for receiving a corresponding one of the protrusions 108.

The protrusions 108 can extend opposite one another such that they extend along a common axis. It is appreciated that the tool 5 can be adapted to rotate about the common axis of the protrusions 108 when gripped by the gripper 58. In other words, engagement of the protrusions 108 by the gripper 58 can block five (5) degrees of freedom of the gripper 58 relative to the coupling assembly 100, whereby axial movement along the three main axes (e.g., X, Y and Z, which are perpendicular to one another) are blocked, along with rotational movement about two of the three axes. As mentioned, the rotational movement which is not blocked is the rotational movement of the gripper about the common axis of the protrusions. In some embodiments, the protrusions 108 can be offset (e.g., not aligned) relative to one another, such that rotation of the tool 5 is at least partially prevented. It should be noted that additional protrusions 108, and corresponding recesses 68 on the gripping attachments 66 can be provided to improve the stability of the tool 5 in the gripper 58 and further prevent rotation of the tool 5 relative to the gripper 58. It is further noted that the gripper anchor 106 can alternatively, or additionally, be provided with female members, such as the recesses, and that the gripper attachments 66 can alternatively, or additionally, be provided with male members, such as the protrusions, for example.

Still referring to FIGS. 2 and 3, the coupling assembly 100 can further include a second coupling removably connectable to the tool 5 and engageable via the robot end effector 56 to improve stability of the tool 5 and precision of the robot performing desired the tasks. The robot end effector 56 is therefore provided with a second gripper portion configured to connect to the second coupling, thereby further securing the tool to the robot. In this embodiment, the second coupling includes a stabilizing coupling 110 removably connected to the tool 5 in a spaced apart relation relative to the gripper coupling 102. The stabilizing coupling 110 can include a stabilizing gripping site engageable with the robot. For example, the stabilizing coupling 110 can be coupled adjacent the proximal end of the tool 5, and more specifically, proximate a proximal end of the handle 7 of the tool 5. In this embodiment, the robot end effector 56 includes a stabilizer 70 adapted to connect to the stabilizing coupling 110, thereby enabling the robot end effector 56 to grab the tool 5 at a plurality of locations (e.g., via the gripper 58 and via the stabilizer 70).

In some embodiments, the stabilizing coupling 110 can include one of a male connector and a female connector, with the stabilizer 70 including the other one of the male and female connectors. In this embodiment, and as seen in FIGS. 2 and 3, the stabilizing coupling 110 includes the female connector 112 extending outwardly therefrom, and therefore from the tool 5, and the stabilizer 70 includes the male connector 72 for connecting with the female connector 112. The female connector 112 can extend from the stabilizing coupling 110 and define the opening for receiving the male connector 72 of the stabilizer 72 therein. In addition, in some embodiments, the stabilizing coupling 110 can be pivotally connected to the stabilizer 70 to facilitate movement of the robot in a 3D environment around the workstation while manipulating and operating the tool 5. In some embodiments, the stabilizer 70 can be adapted to rotate about a longitudinal axis of the robot end effector 56 to allow adjustments of the angle of the tool 5. It should also be noted that connecting the tool 5 to the robot end effector 56 at a second location can eliminate the rotation of the tool about the common axis of the protrusions 108 when grabbed by the gripper 58.

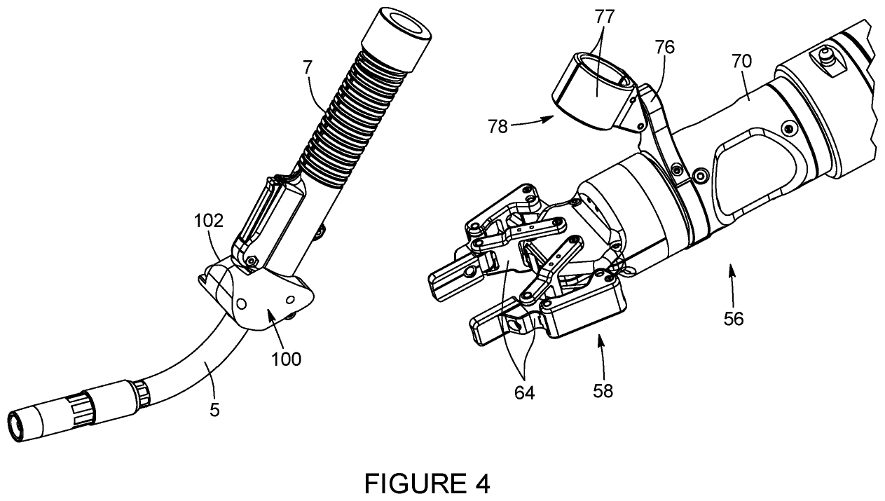

With reference to FIG. 4, an alternate embodiment of the robot end effector 56 and of the coupling assembly 100 is illustrated. In this embodiment, the stabilizer 70 includes a bracket 76 coupled to the robot end effector 56 spaced from the gripper fingers 64. The bracket 76 includes a pair of bracket sections 77 engageable with one another to form a ring 78 adapted to surround a portion of the tool 5, further securing the tool 5 to the robot. In this embodiment, the opening of the ring 78 can be axially aligned with the opening between the gripper fingers 64, although other configurations are possible. The tool 5 can be shaped in a manner to cooperate with the coupling assembly, for example, the handle 7 can include an inner edge adapted to abut the ring 78 of the stabilizer 70 such that the tool 5 can be positioned in a desired/predetermined configuration relative to the robot end effector 56.

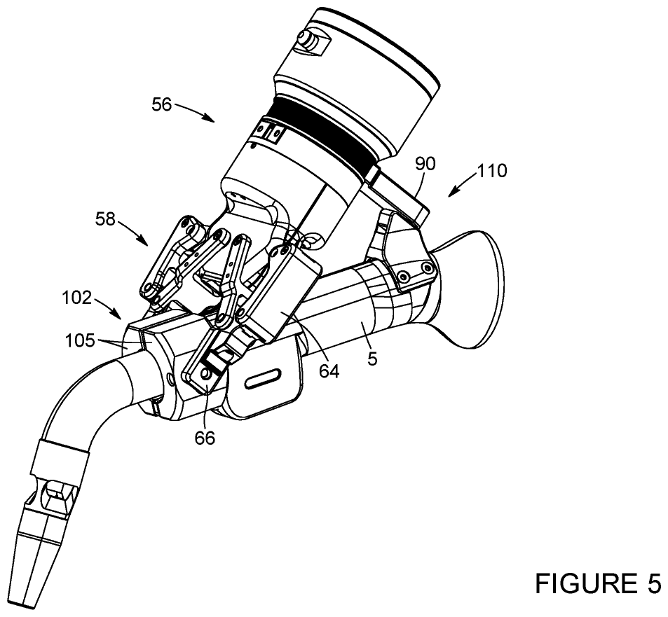

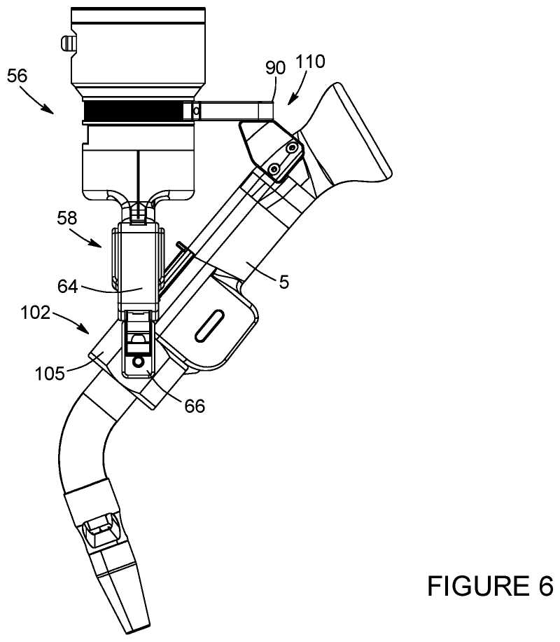

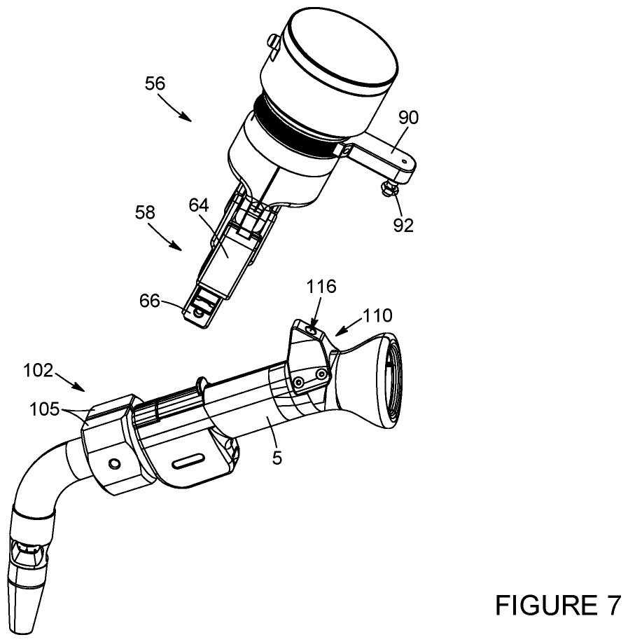

With reference to FIGS. 5 to 8, another embodiment of the robot end effector 56 and of the coupling assembly 100 is illustrated. In this embodiment, the stabilizer 70 includes a projection 90 coupled to the robot end effector 56 spaced from the gripper fingers 64. The projection 90 extends from the stabilizer and includes a male component, such as a connector 92, engageable with the stabilizing coupling 110. More specifically, the stabilizing coupling 110 can include a female connector, such as a connector opening 116 shaped and sized to receive the connector 92. In this embodiment, the connector 92 is linear, substantially straight and extends generally parallel to the robot end effector 56 such that engagement (and disengagement) of the connector 92 with the stabilizing coupling 110 can be done by moving the tool 5 and/or the robot end effector 56 in one direction (e.g., parallel to the longitudinal axis of the connector 92).

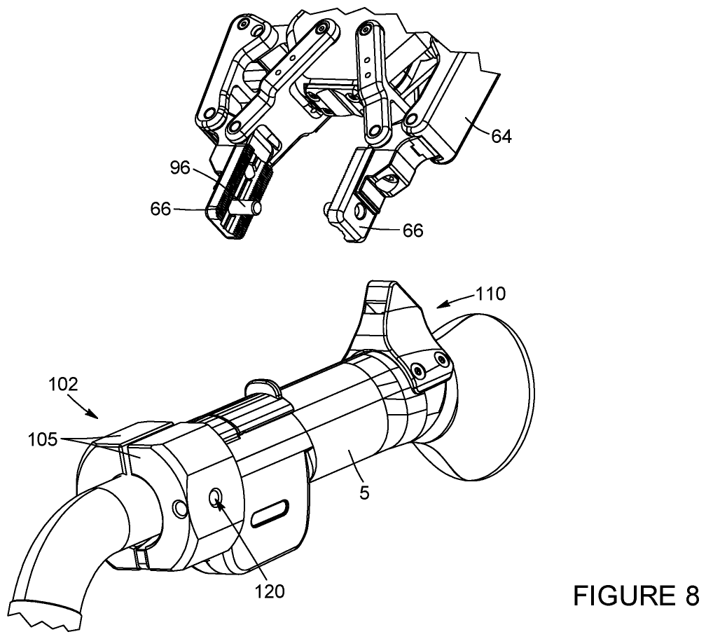

In this embodiment, and as seen in FIG. 8, the gripper coupling 102 includes a pair of complementary components 105, similar to the previously described embodiments. The complementary components 105 are connectable to one another about the tool 5, and can include gripper recesses 120, with the gripping attachments 66 having gripper anchors 96 configured to engage the gripper recesses 120 for coupling the gripping attachments 66 to the tool 5 (e.g., to the gripper coupling 102).

It should thus be understood that the coupling assembly 100 of the various embodiments described above can be adapted to define a plurality of gripping sites (or grasping locations) enabling the robot end effector 56 to be coupled to the tool 5 at different locations. It is noted that the robot is adapted to grab the tool 5 at two separate grasping locations defined by the coupling assembly 100, namely at the gripper coupling 102 and the stabilizing coupling 110. It should be further noted that each grasping location can define one or more contact points. More particularly, in the illustrated embodiments, the coupling assembly 100 enables the robot to grab the tool 5 at least at three different contact points, e.g., in FIGS. 2 and 3, the gripping anchor 106 on a first side of the gripper coupling 102, the gripping anchor 106 on a second side of the gripper coupling 102, and the stabilizing gripping site of the stabilizing coupling 110. However, it is appreciated that other configurations are possible for enabling the robot to grab the tool, and that any other suitable number of grasping locations and/or contact points are possible and can be used.

It should be noted that connecting the tool to the stabilizer 70 can block the sixth degree of freedom which was previously unblocked by the engagement of the gripper 58 with the protrusions 108. As such, providing two or more gripping sites along the tool 5 can substantially block the six (6) degrees of freedom of the tool 5 relative to the gripper (e.g., axial movement along the three axes, and rotational movement about those three axes). It is noted that enabling the robot to grip the tool 5 at different locations can advantageously improve the dexterity and flexibility of the robot, and maintain a repeatability of different tasks performed by the robot.

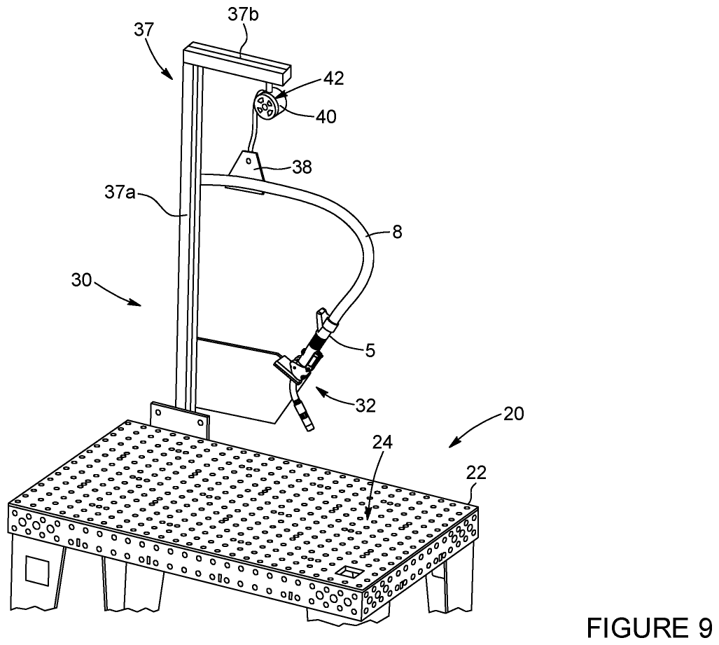

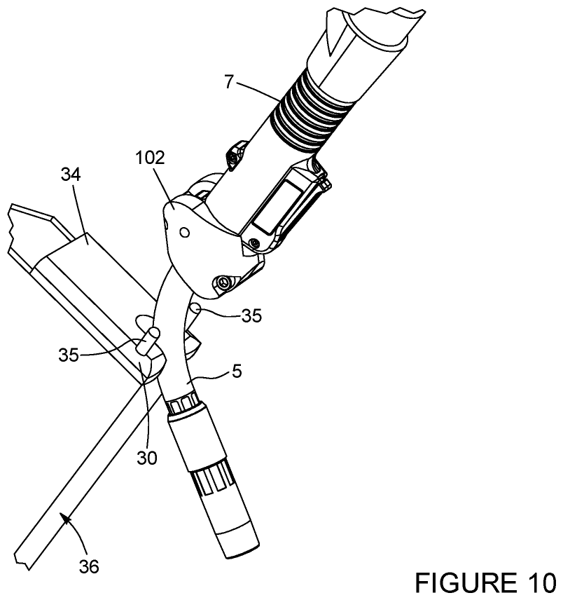

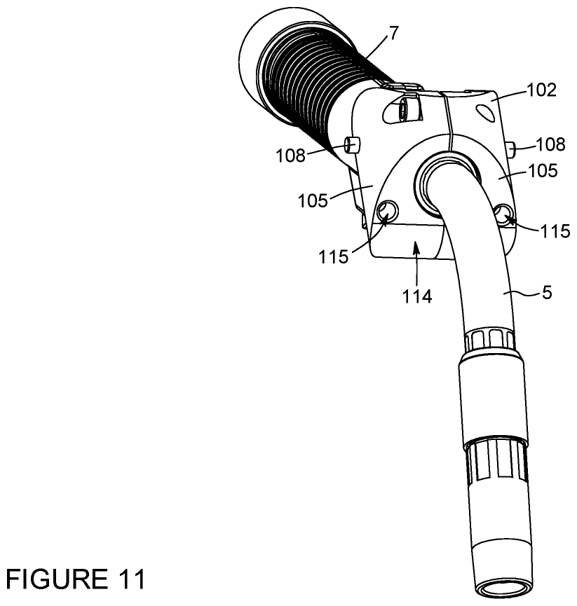

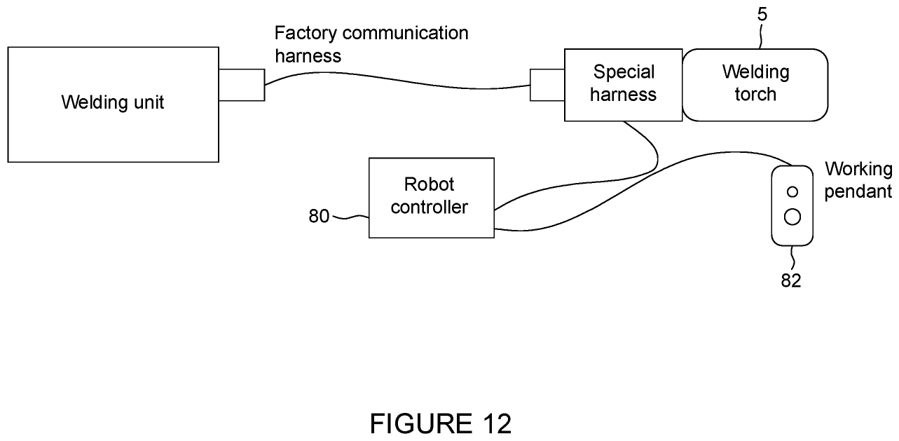

Now referring to FIGS. 9 to 11, the tool support 30 can include a tool holster 32 for supporting the tool 5, for example, when the robot is not manipulating the tool 5. In this embodiment, the coupling assembly 100 can include features or components adapted to engage the tool holster 32 for positioning the tool 5 in a predetermined position relative to the tool holster 32, such as a holstered position. More specifically, the gripper coupling 102 can include a holster interface 114 adapted to engage and cooperate with the tool holster 32 to position the tool in the holstered position.

In this embodiment, the tool holster 32 includes a holster plate 34 and holster studs 35 extending outwardly from the holster plate 34. The holster interface 114 can include complementarily shaped elements, such as holster apertures 115 defined in the gripper coupling 102, with each holster aperture 115 being adapted to receive a holster stud 35 therein. The holster plate 34 can also be shaped and adapted to accommodate for the size and components of the tool 5. For example, in this embodiment, the holster plate 34 includes a pocket 36 shaped and sized to receive a portion of the tool 5, such as the neck of the welding torch. In this embodiment, the tool holster 32 includes a pair of holster studs 35 such that engaging the holster with the tool 5 can block movement of the tool 5 except in the direction of the longitudinal axis of the studs. In other words, from the holstered position, the tool 5 can be picked up and removed from the tool holster 32 by moving it away from the holster plate 34 following the length of the holster studs 35.

Referring more specifically to FIGS. 1 and 9, the tool support 30 can further include a mast 37 extending in the 3D environment of the workstation 20, such as vertically above the welding table 22, for example. The mast 37 can be connected directly to the welding table 22, such as to one of the sides, on the top surface 24 or at any other suitable location. Alternatively, the mast 37 can be adapted to be coupled to the floor proximate the welding table 22. The mast 37 can be provided with a support bracket 38 adapted to support a cable 8 connected to the tool 5 (e.g., power cable, conduits, etc.). The mast 37 can include a generally vertical post 37a extending upwardly, and can further include a support arm 37b extending from the post 37a at a distal end thereof and above the welding table 22. In this embodiment, the support bracket 38 is connected to the support arm 37b in order to position the support bracket 38 in a spaced apart relation relative to the top surface 24. As such, the cable 8 connected to the tool 5 is upheld in an elevated position, away from the tool 5 and top surface 24, thereby preventing interference with the robot during operation thereof.

In some embodiments, the tool support 30 can further include a spool 40 coupled between the support bracket 38 and the support arm 37b. The spool 40 includes a wound-up thread connected to the support bracket 38 and is configured to unwind to enable movement of the support bracket 38. It is thus noted that the robot can manipulate the tool 5 in the 3D environment of the workstation 20, with the cable 8 being kept in an elevated position to prevent interference with the robot, the tool and/or the workpieces, and with the support bracket 38 being allowed to move to prevent the cable 8 from snagging or blocking movement of the tool 5. In this embodiment, the spool 40 includes a self-retracting mechanism 42 such that the thread retracts back into the spool 40, for example, when the tool 5 is moved higher (e.g., toward the spool 40). Furthermore, the self-retracting mechanism 42 enables the support bracket 38 to return to an initial position when holstering the tool 5 on the tool holster 32. In some embodiments, the support arm 37b can be pivotally connected to the post 37a to further improve movement of the robot during operation of the tool 5 (e.g., prevent interference with the movements of the robot end effector 56). In some embodiments, the support arm 37b can include an extension mechanism adapted to allow the spool 40 to move axially along the support arm 37b (e.g., toward and away from the mast 37), further improving the flexibility of the robot while manipulating the tool. For example the extension mechanism can include a rail mounted along the support arm 37b, with the spool being slidably coupled to the rail to enable movement there along. It should be noted that other configurations are possible for enabling improved movement to the components within the robotic cell. For example, the support arm 37b can include two or more telescopically connected segments which enable increasing the length of the support arm 37b and improving the flexibility and mobility of the spool.

Referring back to FIG. 1, the robotic cell 10 includes the tooling library 45 provided proximate the workstation 20 and being accessible by the gripper 58. The tooling library 45 can include a plurality of components adapted to facilitate operation of the tool 5 using the gripper 58. For example, the tooling library 45 can include a plurality of modular elements 46 adapted to be seized, manipulated and positioned in the workstation, such as on the top surface 24 of the welding table 22, by the gripper 58. The tooling library 45 can be provided on a storage shelf provided in or proximate to the workstation 20 to keep the modular elements 46 ordered and accessible via the gripper 58 (or by a worker).

The modular elements 46 are adapted to cooperate with at least one other modular element and/or the top surface 24 to define a workpiece support structure. In other words, the modular elements 46 can be used as building blocks and manipulated by the robot, which can make assembly of a support structure easy and fast to set up. In some embodiments, the workpiece support structure is built by the gripper 58 (e.g., by assembling various modular elements 46 together) and rests on the top surface 24. Then, the gripper 58 can be operated to grab a workpiece and position the workpiece on the workpiece support structure such that the workpiece is in a desired configuration. The gripper 58 can then grab the tool 5 and perform the task on the workpiece, which can be facilitated due to the workpiece's position on the workpiece support structure.

Broadly described, the robotic cell 10 can include a method of performing a predetermined operation using the robot 50. The method can include the steps of grabbing a workpiece using the gripper mounted at a free end of the displaceable robot arm of the robot; positioning and releasing the workpiece in the workstation using the gripper (e.g., on the top surface 24 of the welding table 22); grabbing the tool located in the tool support using the gripper; performing the predetermined operation on the workpiece using the tool held by the gripper; setting down the tool in the tool support using the gripper; and grabbing and removing the workpiece from the workstation using the gripper. The method can further include the step of placing modular elements on the work surface using the gripper to create a workpiece support structure prior to grabbing the workpiece, such that the step of positioning and releasing the workpiece in the workstation includes positioning and releasing the workpiece on the workpiece support structure using the gripper.

The robotic cell 10 can also include a robot controller 80 operatively coupled to the tool 5 and adapted to selectively provide power to the tool 5. For example, an electrical harness can be connected to a welding torch to intercept a signal from a welding source to the welding torch. The electrical harness can be coupled to the robot controller 80 such that a user can control the signal to the robot controller which controls the signal from the welding source for operation of the welding tool. The robot controller 80 can also include a working pendant 82 coupled thereto for controlling the various signals of the robotic cell 10 to control the welding arc.

The robot controller 80 can eliminate the need for programming code to be implemented or required to operate the robot 50. The robot controller 80 can include an interface to allow workers to create a welding program and control the robot by selecting the desired task (e.g., straight welds, curved welds, etc.) and select some parameters, such as welding speed, weld start position, weld end position, among others.

It should be appreciated from the present disclosure that the various implementations of the robotic cell 10 therefore provide several advantages over conventional devices and/or apparatus in that: a) it enables cooperative work between the robot and humans (e.g., welders) sharing the same tool, which can simplify the programming of the robot by allowing the welder to accomplish complex tasks and leave the repetitive work to the robot as required; b) no programming code is required to control the robot; c) the robot can grab and release different components, including the tool, thereby increasing the dexterity and flexibility of the robot; d) the robot can perform other tasks than operating the tool, such as loading the workstation, unloading the workstation, opening and closing toggle clamps, rotating assemblies, and more; e) the coupling assembly enables standard tools to be adapted for manipulation by the robot, thereby eliminating the need and the cost of new equipment for use with the robot cell; f) the tooling library and modular elements enable workpieces to be positioned and welded without a dedicated welding jig, g) etc.

As may now be better appreciated, the robotic cell 10 of the present disclosure can be advantageous in that it provides a robot capable of performing various tasks in a more efficient, more precise, more accurate, more reliable, more adjustable, more versatile, more adaptable, more ergonomic and/or more desirable manner, than what is possible with other existing conventional devices.

The present disclosure may be embodied in other specific forms without departing from the subject matter of the claims. The described example implementations are to be considered in all respects as being only illustrative and not restrictive. For example, in the embodiments described herein, the tool being manipulated and used by the robot is a welding torch. However, it is noted that other types of tools can be used, such as drills, paint brushes or spray paint guns, cutting tools, or any other suitable tools. The gripper can also be provided with additional gripper fingers having different gripping mechanisms. For example, the gripper can additionally or alternatively include magnets selectively operable for grabbing and displacing components in the workstation. In addition, the tool support was described as being adapted to hold a single tool. However, it is appreciated that the robot cell can include a tool support adapted to hold a plurality of tools, such as different sizes of a same tool, different tools, or a combination thereof. Alternatively, the robot cell can include a plurality of tool supports adapted to hold one or more tools thereon, and being accessible by the gripper.

The present disclosure intends to cover and embrace all suitable changes in technology. The scope of the present disclosure is, therefore, described by the appended claims rather than by the foregoing description. The scope of the claims should not be limited by the implementations set forth in the examples, but should be given the broadest interpretation consistent with the description as a whole.

As used herein, the terms “coupled”, “coupling”, “attached”, “connected” or variants thereof as used herein can have several different meanings depending in the context in which these terms are used. For example, the terms coupled, coupling, connected or attached can have a mechanical connotation. For example, as used herein, the terms coupled, coupling or attached can indicate that two elements or devices are directly connected to one another or connected to one another through one or more intermediate elements or devices via a mechanical element depending on the particular context.

In the present disclosure, an embodiment is an example or implementation of the perforation blade. The various appearances of “one embodiment,” “an embodiment” or “some embodiments” do not necessarily all refer to the same embodiments. Although various features may be described in the context of a single embodiment, the features may also be provided separately or in any suitable combination. Conversely, although the robot cell may be described herein in the context of separate embodiments for clarity, it may also be implemented in a single embodiment. Reference in the specification to “some embodiments”, “an embodiment”, “one embodiment”, or “other embodiments”, means that a particular feature, structure, or characteristic described in connection with the embodiments is included in at least some embodiments, but not necessarily in all embodiments.

In the above description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom.

In addition, although the optional configurations as illustrated in the accompanying drawings comprises various components and although the optional configurations of the robotic cell as shown may consist of certain geometrical configurations as explained and illustrated herein, not all of these components and geometries are essential and thus should not be taken in their restrictive sense, i.e., should not be taken as to limit the scope of the present disclosure. It is to be understood that other suitable components and cooperations therein between, as well as other suitable geometrical configurations may be used for the implementation and use of the robot cell, and corresponding parts, as briefly explained and as can be easily inferred here from, without departing from the scope of the disclosure.

What is claimed is:

1. A robotic cell comprising:
a workstation adapted to receive at least one workpiece;
a tool support comprising at least one tool;
a robot comprising:
a robot base positioned proximate the workstation;
a robot arm operatively coupled to the robot base and being displaceable in a 3D environment of the workstation, the robot arm having a free end; and
a robot end effector operatively coupled to the free end and comprising a gripper adapted to selectively seize and release the at least one tool from the tool support and the at least one workpiece;
the tool support being within reach of the gripper, the robot being operable to manipulate and position the workpiece within the workstation using the gripper and perform a predetermined operation on or around the workpiece using the tool held by the gripper.

2. The robotic cell of claim 1, further comprising a coupling assembly comprising a gripper coupling removably connectable to the tool and defining a gripper interface, and wherein the gripper comprises a gripper jaw adapted to engage the gripper interface to seize the tool.

3. The robotic cell of claim 2, wherein the gripper interface comprises a gripper anchor configured to prevent axial movement of the tool relative to the robot end effector when the gripper engages the gripper interface.

4. The robotic cell of claim 3, wherein the gripper jaw comprises two or more gripper fingers provided with gripping attachments, the gripping attachments being complementarily shaped with regards to a portion of the gripper anchor to facilitate engagement of the gripper interface via the gripper.

5. The robotic cell of claim 4, wherein the gripper anchor comprises a pair of protrusions extending opposite one another on either sides of the gripper coupling, and wherein each gripping attachment comprises a recess shaped and adapted to receive a corresponding one of the protrusions.

6. The robotic cell of claim 2, wherein the coupling assembly further comprises a stabilizing coupling removably connectable to the tool in a spaced apart relation to the gripper coupling, and wherein the robot end effector comprises a stabilizer connectable to the stabilizing coupling.

7. The robotic cell of claim 6, wherein one of the stabilizing coupling and the stabilizer comprises a male connector, and wherein the other one of the stabilizing coupling and the stabilizer comprises a female connector.

8. The robotic cell of claim 6, wherein the stabilizer is pivotally connected to the stabilizing coupling.

9. The robotic cell of claim 1, wherein the tool support comprises a tool holster, and wherein the gripper coupling comprises a holster interface adapted to engage the tool holster to position the tool in a predetermined holstered position on the tool holster.

10. The robotic cell of claim 9, wherein the tool holster comprises a holster plate and holster studs extending outwardly from the holster plate, and wherein the holster interface comprises holster apertures shaped and adapted to receive the holster studs therein.

11. The robotic cell of claim 1, wherein the tool support comprises a mast extending in the 3D environment of the workstation and comprising a support bracket adapted to uphold a cable connected to the tool.

12. The robotic cell of claim 11, wherein the tool support comprises a spool connected to the mast and comprising a self-retracting mechanism, the support bracket being connected to the spool, and wherein the spool is adapted to unwind to enable movement of the support bracket.

13. The robotic cell of claim 12, wherein the tool support comprises a support arm pivotally connected to a distal end of the mast, the spool and the support bracket being connected to the support arm.

14. The robotic cell of claim 1, further comprising a modular element library provided proximate the workstation and being accessible by the gripper, the modular element library comprising a plurality of modular elements adapted to be seized, manipulated and positioned in the workstation by the gripper, and wherein the modular elements are adapted to cooperate with at least one other modular element to define a workpiece support structure.

15. A method of performing a predetermined operation using a robot, the method comprising:
grabbing a workpiece using a gripper mounted at a free end of a displaceable robot arm of the robot;
positioning and releasing the workpiece in a workstation using the gripper;
grabbing a tool located in a tool support using the gripper;
performing the predetermined operation on the workpiece using the tool held by the gripper;
setting down the tool in the tool support using the gripper; and
grabbing and removing the workpiece from the workstation using the gripper.

16. The method of claim 15, further comprising the step of placing modular elements in the workstation using the gripper to create a workpiece support structure prior to grabbing the workpiece, and wherein the step of positioning and releasing the workpiece in a workstation using the gripper comprises positioning and releasing the workpiece on the workpiece support structure using the gripper.

17. The method of claim 15, wherein the step of grabbing the tool comprises grabbing the tool at two separate grasping locations using the gripper.

18. The method of claim 17, wherein the grasping locations define one or more contact point, and wherein the gripper is adapted to contact the tool at three separate contact points when grabbing the tool.

19. A coupling assembly connectable to a tool to be manipulated by a robot having a robot end effector comprising a gripper, the coupling assembly comprising:
a gripper coupling provided adjacent a proximal end of the tool and having a gripper interface defining at least two gripping surfaces engageable by the gripper; and
a stabilizing coupling spaced apart from the gripper coupling along the tool and comprising a stabilizing gripping site engageable with the robot,
the coupling assembly being detachably engageable by the robot at the at least two gripping surfaces and the stabilizing gripping site.

20. The coupling assembly of claim 19, in combination with a robot end effector adapted to grip the tool and be manipulated by a robot, the robot end effector comprising:
a gripper comprising a gripper jaw adapted to engage the at least two gripping surfaces to seize the tool; and
a stabilizer spaced apart from the gripper and engageable with the stabilizing gripping site of the stabilizing coupling,
the robot end effector being adapted to detachably engage the tool at the at least two gripping surfaces and the stabilizing gripping site of the coupling assembly.
